(19) United States
(12) Patent Application Publication
(10) Pub. No.: US 2025/0019845 A1
(43) Pub. Date: Jan. 16, 2025

(54) METHOD OF PREPARING ULTRATHIN METAL-ORGANIC FRAMEWORKS AS DUAL-ATOM ELECTROCATALYSTS FOR CARBON DIOXIDE REDUCTION

(71) Applicant: THE HONG KONG UNIVERSITY OF SCIENCE AND TECHNOLOGY, HONG KONG (CN)

(72) Inventors: ZHENGTANG LUO, HONG KONG (CN); YA HUANG, HONG KONG (CN)

(21) Appl. No.: 18/349,174

(22) Filed: Jul. 10, 2023

(51) Int. Cl. C25B 11/085; C25B 3/26; C25B 9/19; C25B 11/02; C25B 11/042; C25B 11/052; C25B 11/065; C25B 13/08; C25B 15/08

(52) U.S. Cl. CPC C25B 11/085; C25B 3/26; C25B 9/19; C25B 11/02; C25B 11/042; C25B 11/052; C25B 11/065; C25B 13/08; C25B 15/08

(57) ABSTRACT

This disclosure provides methods and apparatus with regard to ultrathin metal-organic frameworks for the application of carbon dioxide reduction. In one aspect, a method of preparing metal-organic frameworks by copper and second metal ion clusters coordinating with metalloporphyrinic linkers. In the other aspect, the metal-organic frameworks are coated on the working electrode as electrocatalysts for carbon dioxide reduction are presented.

### TECHNICAL FIELD

The present disclosure is generally related to the preparation method of ultrathin metal-organic frameworks that comprising copper ions and second metal ions like zinc ions or tin ions, as dual-atom electrocatalysts to an application of electrochemical carbon dioxide reduction towards gaseous and liquid products.

### BACKGROUND

The demand for green energy has become increasingly urgent over these decades. Continued carbon emission into the air leads to the greenhouse effect that need to be mitigated. Although renewable energy sources such as solar and wind are widely promoted, the low energy conversion rates impel researchers to find highly selective and energy-saving substituents. The carbon cycle proposed in recent years is a viable envisage that achieves a favorable conversion of carbon-based compounds by reconverting the carbon dioxide released by combustion into high-value added products. Among the approaches that have been investigated, electrochemical CO₂ reduction (ECR) offers benefit of long term, large-scale and room temperature operation, in addition renewable electricity can be integrated into the system.

However, the selectivity towards multi-carbon products and suppress in the competing hydrogen evolution reaction require delicate design of the electrocatalyst engaged. In general, minimizing the size of metal catalysts is a widely used technique because the high surface area, nano-sized effect and low-coordinated environment result in enhanced reactivity than bulk structure. The dual-atom catalysts (DACs) have raised attention recently that they reach a high level of atom utilization and offer a great potential for high activity and selectivity towards CO₂ electroreduction. Moreover, compared with single-atom catalysts, two active sites make it possible to break the linear scaling relations among the complicated intermediates, leading to more carbon-carbon coupling. However, the aggregation of atoms significant hinders the application of DACs. Using two-dimensional (2D) support can largely reduce the surface energy and fixation the individual metal atoms, enables DACs to persist as an electrocatalyst during ECR.

Metal-organic frameworks (MOFs) are an emerging class of hybrid porous materials that offer the benefits of adjustable modules and regular mesopore distribution. Several examples on three-dimensional MOF-derived electrocatalysts have been reported including the zeolitic imidazolate frameworks (like ZIF-8). However, the pyrolysis process making the catalysts conductive is always gather metal atoms into clusters. In addition, the catalytic reaction generally arises from the surface or inside pores. Therefore, during the electrolysis, the highly porous MOFs provide more exposed active sites for CO₂ molecules to attach, elongate the retention time of reactants and catalysts. The three-dimensional morphology reduces accessibility of internal metal sites to reactants. Thus, a 2D MOFs can act like the support for DACs to alleviate the steric hindrance and provide effective catalytic performance for ECR.

### SUMMARY

Embodiments described herein relate to the dual-atom catalysts for ECR allowing for highly efficient conversion of carbon dioxide to value-added products. The dual-atom electrocatalysts with uniformly loaded transition metals and high surface area are derived from two-dimensional metal-organic frameworks. The present disclosure is generally related to methods of preparing the ultrathin support materials and tunable implementing of transitional metal collocations. The dual-atom catalysts demonstrate high selectivity towards CO₂ reduction and generate C₂ chemicals.

In one aspect, the preparation method of dual-atom catalysts derived from MOFs materials is provided, where the method includes the surfactant-assistant solvothermal reaction process. And a chemical combination between MOF precursors and carboxylic acid modified carbon nanotubes for enhanced C₂₊ production. The details are shown below:
S1: Preparing the metal cluster precursor by adding Cu(NO₃)₂·3H₂O, trifluoroacetate and polyvinylpyrrolidone in a 20 mL Pyrex vial and dissolving them with 9 mL DMF and 3 mL ethanol;
S2: Preparing the organic precursor by adding 5,10,15,20-tetrakis(4-carboxyphenyl) porphine (TCPP) and copper acetate in a 50 mL Pyrex vial and dissolving them with 30 mL DMF, then reflux at 150° C. for 10 hours. Similar procedures are using to prepare SnTCPP linker except changing the metal salt to tin (II) chloride. The CuTCPP and SnTCPP linkers are washed with acetone and centrifuged to collect purple crystals at the bottom;
S3: CuTCPP linkers and SnTCPP linkers are dissolved in 3 mL DMF and 1 mL ethanol and added into the vial in S1 under stirring. Then, the mixture is heating at 80° C. for 16 hours after sonication for 15 min;
S4: The mixture is centrifuged and collected the bottom purple powder, washed thoroughly with DMF, and activated by acetone for five days;
S5: The obtained Cu—Cu/SnTCPP MOF nanosheets are dried in vacuum at 80° C. overnight. The control sample, Cu—CuTCPP MOF nanosheet, is prepared by the same method except only CuTCPP linkers are used in S3 step.

In another aspect, the electrochemical reduction of CO₂ is carried out in a three-electrode system comprising a gas-tight H-type glass cell with a reference electrode of Ag/AgCl (saturated in 3M KCl solution) and a counter electrode of a coiled platinum wire, wherein the MOF catalyst supported with glassy carbon electrode as working electrode is provided.

In a further aspect, the CO₂ reduction cell is connected with a gas chromatography (GC) instrument to investigate the gaseous products. The process may include applying several applied potentials on working electrode and implement detect the gas generation. The liquid product composition is provided by proton nuclear magnetic resonance (¹H NMR), and the Faradic efficiencies are also provided.

### BRIEF DESCRIPTION OF THE DRAWINGS

FIG. 1 schematically demonstrates the synthesis of Cu—Cu/SnTCPP MOF nanosheets with the surfactant-assistant method.

FIG. 2A is a representative scanning electron microscopy (SEM) image of assembled MOF nanosheets in low magnification.

FIG. 2B is a magnified SEM figure of one typical assembled MOF nanosheets.

FIG. 3A is a representative transmission electron microscope (TEM) image of one piece of Cu—Cu/SnTCPP MOF nanosheet.

FIG. 3B is a representative high-solution TEM image of Cu-Cu/SnTCPP MOF nanosheet with lattice fringe of 3.2 nm.

FIG. 4A is a representative atomic force microscopy (AFM) image of assembled MOFs before sonication.

FIG. 4B is a representative AFM image the ultrathin MOF nanosheets after sonication.

FIG. 5 is a representative graph of thermogravimetric analysis (TGA) of Cu—Cu/SnTCPP MOF nanosheets.

FIG. 6 is a representative X-ray diffraction (XRD) pattern of Cu—Cu/SnTCPP MOFs and Cu—CuTCPP MOFs.

FIG. 7 is a graph of linear sweep voltammetry (LSV) curves performed in a 0.1 M aqueous potassium bicarbonate electrolyte at a scan rate of 1 mV s⁻¹ with two MOF catalysts as working electrodes, respectively.

FIG. 8 represents the cyclic voltammetry (CV) curves of two MOF catalysts during CO₂ electroreduction.

FIG. 9 is a graph of Faradaic efficiencies of three gaseous products detected by gas chromatography during 1 hour of CO₂ electroreduction.

FIG. 10 is a representative figure of liquid products obtained from the electrolyte and tested by proton nuclear magnetic resonance (¹H NMR).

### DESCRIPTION OF EMBODIMENTS

Various embodiments are described below. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Herein are described a novel class of dual-atom catalysts for CO₂ electroreduction derived from MOF structure. The advantages of these catalysts are the varied composition of two transition metals and high dispersity caused by the periodic porous frameworks. Such dual-atom electrocatalysts are prepared in the following steps:
S1: Preparing the metal cluster precursor by adding Cu(NO₃)₂·3H2O (3.6 mg, 0.015 mmol), CF₃COOH (20 μL, 1.0 M) and PVP (10.0 mg) in a 20 mL Pyrex vial and dissolving them with DMF (9 mL) and ethanol (3 mL);
S2: Preparing the organic precursor by adding 5,10,15,20-tetrakis(4-carboxyphenyl)porphine (TCPP) (20 mg) and copper acetate (54.3 mg, 0.3 mmol) in a 50 mL Pyrex vial and dissolving them with DMF (30 mL), then reflux at 150° C. for 10 hours. Similar procedures are using to prepare SnTCPP linker except changing the metal salt to Tin (II) chloride (56.9 mg. 0.3 mmol). The CuTCPP and SnTCPP linkers are washed with acetone and centrifuged to collect purple crystals at the bottom;
S3: In one embodiment, CuTCPP linkers (3.4 mg. 0.004 mmol) and SnTCPP linkers (0.9 mg. 0.001 mmol) are dissolved in DMF (3 mL) and ethanol (1 mL) mixture and dropwisely added into the vial in S1 under stirring. The mixture is sonicated for 15 min before heating in an oven at 80° C. for 16 hours; In another embodiment, Cu-CuTCPP MOF nanosheets as control sample, are prepared by only adding CuTCPP linkers (4.25 mg. 0.005 mmol) in S3 step.
S4: After the reaction, the mixture is centrifuged and collected the bottom purple powder, washed thoroughly with DMF, and activated by acetone for five days;
S5: Finally, the obtained Cu—Cu/SnTCPP and Cu—CuTCPP MOF nanosheets are subjected to vacuum drying at 80° C. overnight.

Following the catalyst preparation, the electrochemical reduction of CO₂ is carried out in a gas-tight electrochamical H-type glass cell. The reference electrode (RE) is Ag/AgCl (saturated in 3M KCl solution) and the counter electrode (CE) is a coiled platinum wire. The as-prepared dual-scale electrode can be spread evenly with a Nafion binder on the glassy carbon electrode as a working electrode (WE). The anodic and cathodic chambers are connected by a clamp and there is a proton exchange membrane Nafion 117 in between. Each chamber contains 50 mL CO₂-saturated 0.1 M KHCO₃ and a stirring bar must be added in the cathodic chamber during electrolysis to help product bubbles detaching from the WE surface. Before the electrochemical test, the electrolyte in each compartment was purged with CO₂ at 20 sccm for 30 min to make sure the electrolyte is CO₂-saturated. The average flow rate of CO₂ was controlled at the inlet of the cell by a standard series mass flow controller and re-check by a bubble flow meter. Both chambers have CO₂ inlet in the same flow rate, where CO₂ will directly flow out from the anodic outlet but will lead to a U-shape condenser in icy bath from the cathodic one for reducing the moisture in the gases. The GC will collect and detect the gases from the other outlet of this condenser. During the 60 minutes experiment at a fixed potential, the workstation is employed to recode the amperometric i-t curve by applying a constant potential to WE.

### EMBODIMENTS

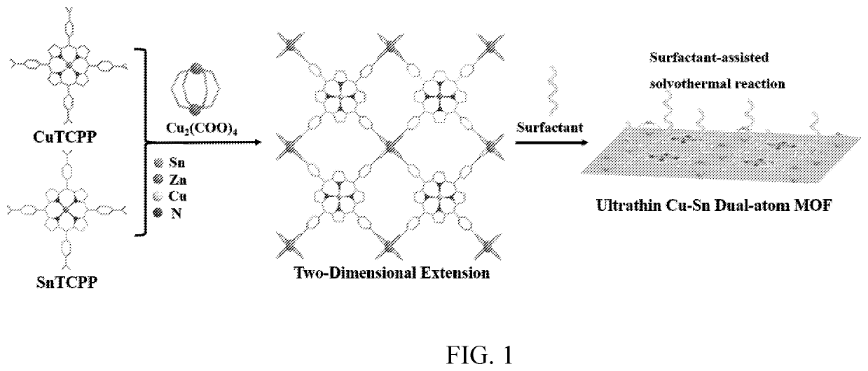

Embodiment 1. A schematic illustration of the preparation methodology of dual-atom catalysts derived from MOFs is shown in FIG. 1. The methodology includes the surfactant-assistant solvothermal reaction process to produce two-dimensional MOF nanosheets. First, to prepare the organic precursor by adding 5,10,15,20-tetrakis(4-carboxyphenyl)porphine (TCPP) and copper acetate in a 50 mL Pyrex vial and dissolving them with 30 mL DMF, then reflux at 150° C. for 10 hours. Similar procedures are using to prepare SnTCPP linker except changing the metal salt to tin(II) chloride. The CuTCPP and SnTCPP linkers are washed with acetone and centrifuged to collect purple crystals at the bottom; Next, to prepare the metal cluster precursor by adding Cu(NO₃)₂·3H₂O, trifluoroacetate and the surfactant polyvinylpyrrolidone in a 20 mL Pyrex vial and dissolving them with 9 mL DMF and 3 mL ethanol; Following that, the mixture of two precursors is heating at 80° C. for 16 hours after sonication for 15 min; The product is centrifuged and washed thoroughly with DMF, and activated by acetone for five days.

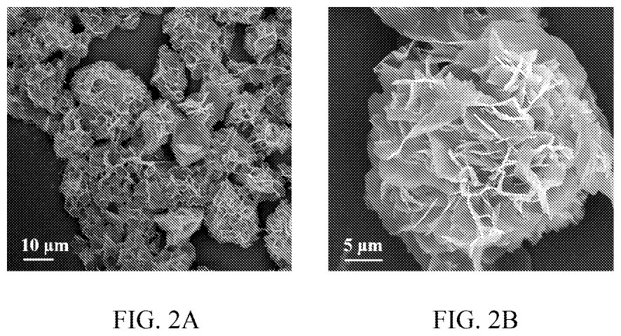

Morphology characterization of the MOF nanosheets through scanning electron microscopy (SEM) is revealed in FIG. 2A. It is shown that the MOFs are not three-dimensional growth as their z-axis growth is suppressed by the surfactant. The nanosheets are self-assembled into the nanoflower-shape to reduce the surface energy (FIG. 2A). And enlarged figure in FIG. 2B shows the morphology of soft flake of each MOF nanosheets.

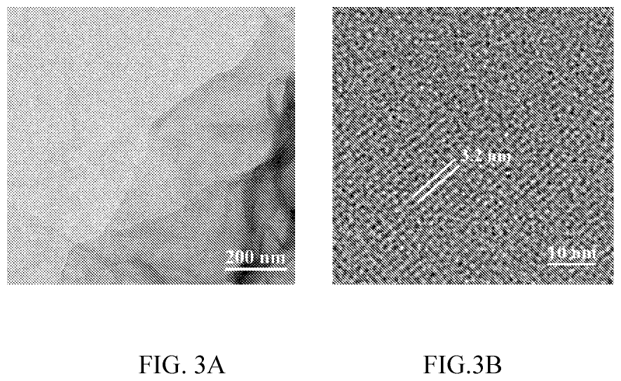

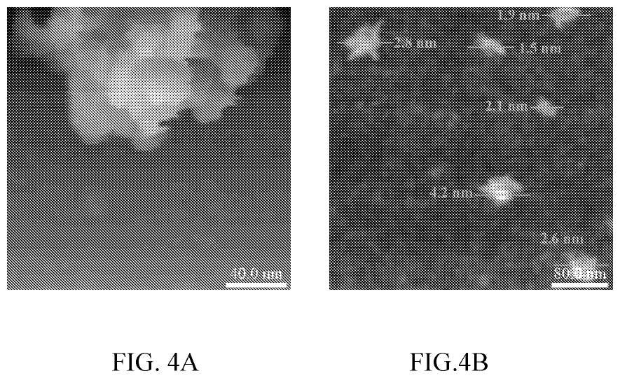

Futher characterization of the ultrathin feature of the MOFs conducted by transmission electron microscope (TEM) is shown in FIGS. 3A and 3B. The FIG. 3A displays a typical piece of MOF nanosheet and the high-resolution TEM image (FIG. 3B) shows the lattice fringe of the resulting MOFs is 3.2 nm. FIG. 4A illustrates the atomic force microscopy (AFM) images of the MOF-assembled nanoflowers and FIG. 4B displays the split nanosheets. The height profiles of nanosheets are labeled according and the average thickness is 2 nm, which are also confirmed that this synthesis method can produce ultrathin MOFs.

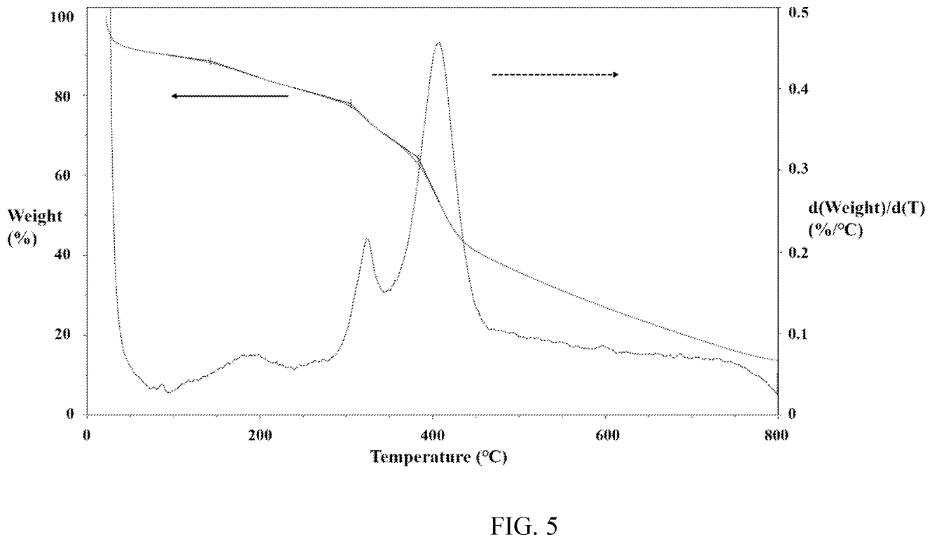

Embodiment 2. The properties of synthetic MOFs are also evaluated to better understanding the material. FIG. 5 shows the thermogravimetric analysis (TGA) curves and deriv. weight (%/° C.) vs. temperature of Cu—CuTCPP MOFs. The MOFs maintain thermal stability until 305° C. and main weight loss happens at around 400° C., which is a robust substrate.

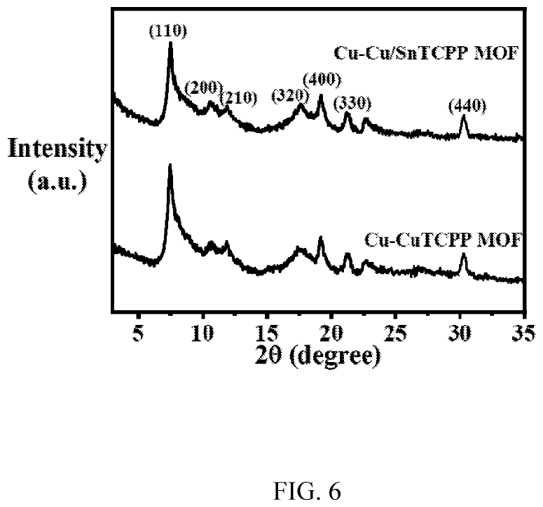

The powder X-ray diffraction (PXRD) analysis in FIG. 6 reveals that the MOF catalysts possess good crystallinity and changing the transition metal ions inside the frameworks does not affect the crystallinity. Therefore, the MOF structure is envisioned to have template potency for diatomic catalysts.

Embodiment 3. The electrochemical reduction of CO₂ is carried out in a gas-tight H-type glass cell. The reference electrode (RE) is Ag/AgCl (saturated in 3M KCl solution) and the counter electrode (CE) is a coiled platinum wire. The as-prepared dual-scale electrode can be spread evenly with a Nafion binder on the glassy carbon electrode as a working electrode (WE). The area of WE is 1×1 cm². The anodic and cathodic chambers are connected by a clamp and there is a proton exchange membrane Nafion 117 in between. Each chamber contains 50 mL CO₂-saturated 0.1 M KHCO₃ and a stirring bar must be added in the cathodic chamber during electrolysis to help product bubbles detaching from the WE surface.

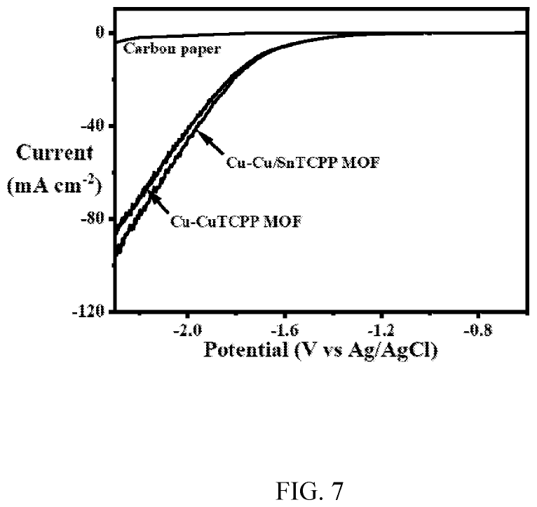

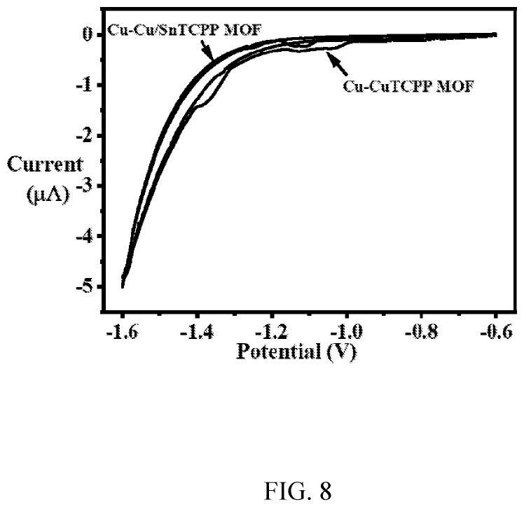

A three-electrode system as mentioned above is used for Linear sweep voltammetry (LSV) testing first. FIG. 7 illustrates the LSV results of two dual-atom MOF catalysts and carbon paper at 1 mV s⁻¹. The onset potentials of two MOFs are similar and the resistances are small that a low overpotential can generate sufficient currents. FIG. 8 demonstrates the typical cyclic voltammetry (CV) curves of Cu—CuTCPP MOF catalyst and Cu—SnTCPP catalyst in the same three-electrode system. All the galvanostatic discharge-charge performance was obtained in the CHI 660E series electrochemical workstation.

Embodiment 4. Before the electrochemical test, the electrolyte in each compartment was purged with CO₂ at 20 sccm for 30 min to make sure the electrolyte is CO₂-saturated. The average flow rate of CO₂ was controlled at the inlet of the cell by a standard series mass flow controller and re-check by a bubble flow meter. Both chambers have CO₂ inlet in the same flow rate, where CO₂ will directly flow out from the anodic outlet but will lead to a U-shape condenser in icy bath from the cathodic one for reducing the moisture in the gases. The gas chromatography (GC) will collect and detect the gases from the other outlet of this condenser.

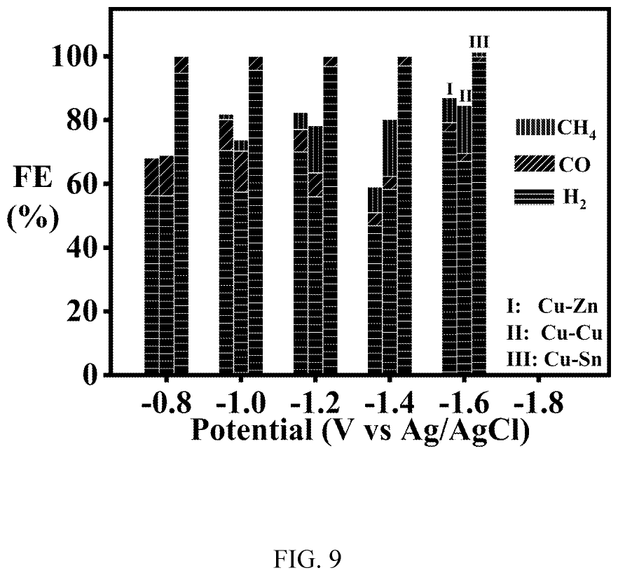

The Faradaic efficiencies of the gasous products after electrochemical CO₂ reduction using the dual-atom catalysts in Embodiment 1 and conducted followed by the three-electrode system descripted in Embodiment 3 are summaried in FIG. 9. It should be noted that no pyrolysis step is required for the MOF-derived catalysts to conduct electrochemical reaction as they have sufficient electrical conductivity to achieve electrolysis. The potentials applied to the electrocatalytic cell vary from −0.8 V to −1.6 V. And the diatomic pairs of Cu—Zn, Cu—Cu and Cu—Sn are presented respectively. Compared with the addition of Zn atoms into the catalysts, the Sn and Cu can effectively suppress the hydrogen evolution reaction.

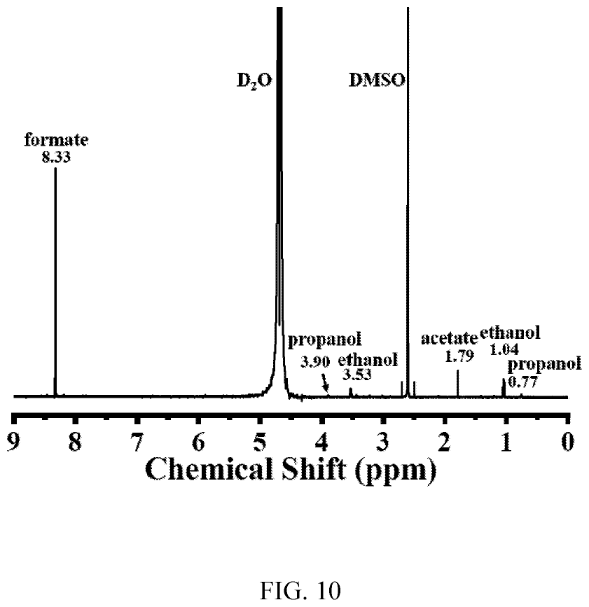

Embodiment 5. The Faradaic efficiencies of the liquid products should be calculated from NMR results by taking out the cathode electrolyte after 30 min or 1 h of electrochemical CO₂ reduction. Typically, 1 ml of electrolyte is drawn out from cathode chamber and combined with 100 μL deuterium oxide (D₂O) and 5 μL dimethyl sulfoxide (DMSO) as internal standard. FIG. 10 demonstrates a NMR spectrum of liquid products catalyzed by Cu—CuTCPP MOFs after 30 min electroreduction. The 8.33, 1.04, 1.79 and 0.77 are assigned to formate, ethanol, acetate and propanol, respectively. The Faradaic efficiencies of each product can be quantified by integrating the area of each peak compared to the DMSO peak area.

What is claimed is:

1. A method of preparing ultrathin metal-organic frameworks, comprising:
reacting a porphyrinic structured organic linker with a transition metal ion, and the transition metal ion comprising copper or tin; preparing the metal precursors by dissolving copper salts, and an addition of surfactant into the solution to ensure a good mix; generating the metal-organic framework by combining organic ligand solution and metal precursor at 80° C. for 24 hours; and washing the precipitate by centrifugation at 10000 rmp for 10 minutes in DMF three times and activating them by acetone and then vacuum drying at 80° C. to collect the materials.

2. The method of claim 1, wherein a portion of the porphyrinic organic linkers is metallization with the second ions like zinc ions or tin ions.

3. The method of claim 1, wherein the morphology is ultrathin with a thickness vary from 1.5 nm to 5 nm.

4. The method of claim 1, wherein providing the apparatus of electrochemical H-type cell, comprising an Ag/AgCl as reference electrode; a coiled platinum wire as counter electrode; a glassy carbon coating with MOF catalyst as working electrode; a pre-activated Nafion 117 membrane as a separator; an aqueous electrolyte comprising 0.1 M or 0.5 M potassium hydrogen carbonate; and a carbon dioxide cylinder providing CO₂ flow thereof.
